(19) United States
(12) Patent Application Publication
(10) Pub. No.: US 2026/0172754 A1
(43) Pub. Date: Jun. 18, 2026

(54) MICROPHONE SYSTEM

(71) Applicant: Harman Becker Automotive Systems GmbH, Karlsbad (DE)

(72) Inventors: László Gergely HORICSÁNYI, Karlsbad (DE); Áron KOCSIS, Karlsbad (DE)

(73) Assignee: Harman Becker Automotive Systems GmbH, Karlsbad (DE)

(21) Appl. No.: 19/423,449

(22) Filed: Dec. 17, 2025

(30) Foreign Application Priority Data
Dec. 18, 2024 (EP) 24 221 121.7

(51) Int. Cl. H04R 7/02; H04R 1/04; H04R 1/06; H04R 7/22

(52) U.S. Cl. CPC H04R 7/02; H04R 1/04; H04R 1/06; H04R 7/22; H04R 2201/003; H04R 2499/13

(57) ABSTRACT

A system is described that comprises a housing, a flexible printed board circuit, PCB, and a sensor. The flexible PCB has a first surface that is exposed to an environment and a second surface that is opposite the first surface. The flexible PCB is mounted to the housing by a mounting element. At least a portion of the flexible PCB is configured to vibrate when an acoustic wave reaches the first surface. The sensor is arranged on the second surface of the flexible PCB and is configured to measure vibrations of the flexible PCB and to output a corresponding electrical signal.

### CROSS-REFERENCE TO RELATED APPLICATIONS

This application claims priority to EP Application No. 24221121.7 filed Dec. 18, 2024, the disclosure of which is hereby incorporated in its entirety by reference herein.

### TECHNICAL FIELD

This application relates to the field of microphones, in particular to Micro Electro-Mechanical Systems, MEMS, microphones that can be arranged on a vehicle.

### BACKGROUND

MEMS microphones are miniaturized microphones that can be applied directly on an electronic circuit board. The membrane of the microphone may be etched directly into the silicon wafer. The microphone components are then placed on a printed circuit board and protected with a mechanical cover. MEMS microphones can be integrated in many fields, such as in the automotive field.

One problem with this design is that the microphones require a port hole in the mechanical cover through which sound can enter and reach the diaphragm of the MEMS microphone. Such an opening is vulnerable to the elements of the environment, such as water, dust and debris.

A known solution for this problem is to use a mesh or a plastic shield to protect the port hole. However, in practice, such shields can get clogged with mud and debris, which severely impairs the performance of the microphone and can be difficult to clean.

The inventors have set themselves the objective to provide a system that is configured to be used as microphone for an automobile, wherein the microphone is sensitive enough for voice recognition and is robust against external influences, such as water, dust, and debris.

### SUMMARY

The above-mentioned objective is achieved by the system of claim 1, in particular by using a flexible PCB as the membrane for the microphone, wherein a MEMS sensor configured to measure the vibrations of the flexible PCB membrane is arranged directly on the flexible PCB. The surface of the flexible PCB that is exposed to the environment is empty, while the surface of the flexible PCB on which the MEMS sensor is arranged is sealed away from the environment. With this, the system is not affected by impurities from the environment. In addition, the system is very compact while keeping the overall assembly relatively simple and cost-efficient.

In one example, the disclosure is directed to a system that comprises a housing, a flexible printed board circuit, PCB, and a sensor. The flexible PCB has a first surface that is exposed to an environment and a second surface that is opposite the first surface. The flexible PCB is mounted to the housing by a mounting element. At least a portion of the flexible PCB is configured to vibrate when an acoustic wave reaches the first surface. The sensor is arranged on the second surface of the flexible PCB and is configured to measure vibrations of the flexible PCB and to output a corresponding electrical signal.

### BRIEF DESCRIPTION OF THE DRAWINGS

The embodiments described herein can be better understood with reference to the following description and drawings. The components in the figures are not necessarily to scale, emphasis instead being placed upon illustrating the principles of the embodiments. Furthermore, in the figures, like reference numerals designate corresponding parts. In the drawings:

FIG. 1 illustrates a first example of a microphone system in a side view in accordance with one or more techniques described herein.

FIG. 2 illustrates an example of a flexible PCB that can be used in the system of FIG. 1 in a view from above.

FIGS. 3A, 3B, and 3C each illustrate a cross-sectional areas of a second example of a microphone system in accordance with one or more techniques described herein (A) in a side view and without a plug element, (B) in a perspective view from below and without a plug element and (C) in a perspective view from above and with a plug element.

FIG. 4 illustrates a third example of a microphone system in a side view in accordance with one or more techniques described herein.

FIG. 5 illustrates a fourth example of a microphone system in a side view in accordance with one or more techniques described herein.

### DETAILED DESCRIPTION

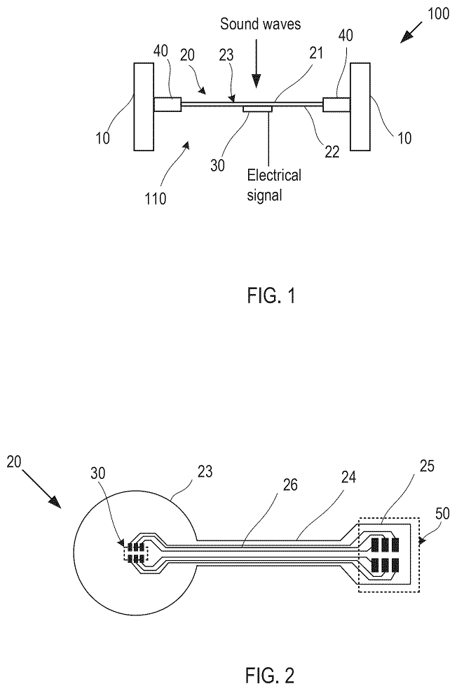

FIG. 1 shows an example of a microphone system 100. The microphone system 100 comprises a housing 10, a flexible printed board circuit, PCB, 20 and a sensor 30. A flexible PCB is a PCB that can be bent, folded or twisted. The housing 10 may be made of any suitable material, such as plastic or metal. In one example, the housing 10 is made of an injection-molded plastic material that can be used in an injection molding machine. In one example, the housing 10 is made of a glass fiber reinforced plastic material. In another example, the housing 10 is made of a nylon material. With this, the housing can be manufactured in a simple and cost-efficient manner. In one example, the housing 10 is made of a single piece. In another example, the housing 10 comprises at least two housing parts that are connected to each other. The housing 10 may comprise at least one opening 110. In one example, the opening 110 may be open at both ends. In another example, the opening 110 may be closed off at one end.

The flexible PCB 20 is mounted to the housing 10 by a mounting element 40. The flexible PCB 20 has a first surface 21 that is at least partially exposed to an environment, in particular to sound waves (acoustic waves) emitted in this environment. The first surface 21 may be directly exposed to an environment. In another example, the first surface 21 is separated from the environment by a grid (not shown) that is configured to stop large impurities from reaching the first surface 21 of the flexible PCB 20. The flexible PCB 20 also comprises a second surface 22 that is opposite the first surface 21. At least a first portion 23 of the flexible PCB 20 is configured to vibrate when an acoustic wave reaches the first surface 21. The vibration of the flexible PCB is thus indicative of an incoming acoustic signal. With this, the first portion 23 of the flexible PCB 20 can act as a microphone membrane that is sensitive to acoustic waves.

In one example, the first portion 23 of the flexible PCB 20 is arranged in the opening 110 of the housing 10. In one example, the first portion 23 of the flexible PCB 20 is free-standing. The first portion 23 is only supported by the housing 10 at at least one end. In one example, an edge of the first portion 23 is attached to the housing 10. Since the first portion 23 of the flexible PCB 20 is free-standing, it can vibrate according to the external pressure, such as acoustic waves. A movement of the first portion 23 of the flexible PCB 20 is thus indicative of the sound waves in the outer environment.

The sensor 30 is arranged on the second surface 22 of the flexible PCB 20 (i.e. the surface that is not exposed to the environment) and is configured to measure vibrations of the flexible PCB 20 and to output a corresponding electrical signal. In one example, the sensor 30 is a MEMS accelerometer that is configured to measure an acceleration of the first portion 23 of the flexible PCB 20. The sensor 30 is mounted to the first portion 23 of the flexible PCB 20. In one example, the sensor 30 is arranged on the middle of the first portion 23. In one example, the sensor 30 is soldered on the second surface 22 of the flexible PCB 20. In one example, the sensor 30 outputs an electrical signal to an analysis circuit (not shown in FIG. 1), such as an amplifier circuit. The analysis circuit may be connected to an electronic system of a vehicle. The sensor 30 may be digital or analog.

In one example, the sensor 30 is a bone conduction sensor, such as a sensor of type SV01-003 (analog sensor) or SDV01-003 (digital sensor). These sensors are highly sensitive and have a frequency response that make them suitable for reliable human voice recognition. They also have a high sound-to-noise-ratio and are able to efficiently shield the ambient sound noise. In addition, they are very compact.

The system 100 can work as a conventional MEMS microphone, wherein the flexible PCB 20 acts as the membrane of the microphone. When an acoustic wave reaches the flexible PCB 20, the flexible PCB 20 vibrates according to the acoustic wave. The sensor 30 detects the vibrations of the membrane and transmit an output signal that is indicative of the acoustic signal to an amplifier circuit. The amplifier circuit may be connected to an automobile electronics. Since the flexible PCB 20 itself is the membrane, there is no need to have a port hole for transmitting the sound to the diaphragm. With this, electronic components of the flexible PCB 20, in particular the sensor 30, can be protected from moisture, dust and other impurities from the environment. In one example, the system 100 has a level of protection IP69, which indicates that the system 100 is fully dust-and water-tight. This makes it possible to arrange it directly on a surface of a car, such as a door. The manufacturing of the microphone is also particularly easy as all the necessary components necessary can be arranged on a single flexible PCB. In particular, press-fit pins can be used to connect the flexible PCB to the outside, for example for data exchange or for powering the components of the flexible PCB, so that there is no need to use any wires inside the microphone itself.

In one example, the system 100 is implemented in a vehicle. The system 100 may be arranged on the inner or outer side of a vehicle. This is made possible because the components of the system 100 are sealed away from the environment. Usual microphones having a port hole would rapidly get clogged due to the accumulation of impurities in the microphone, leading to a decreased sensitivity of the microphone and, in worst cases, to a full failure of the microphone. In one example, the system 100 is configured to detect a sound from an emergency vehicle in the street and output a corresponding signal to the automobile electronics. The automobile electronics may then inform the driver of the presence of the emergency vehicle. With this, the car safety can be increased. In another example, the system 100 is configured to detect a human voice, and to output a corresponding signal to the automobile electronics, which may trigger an action from the vehicle. The detected human voice may contain a command and the automobile electronics may carry out the corresponding command. The system 100 may be arranged on an outer side of the vehicle, such as a door or a rearview mirror, and detect a voice command even when the car user is outside the vehicle. With this, the communication between the user and the vehicle can be improved. The system 100 is particularly compact and easy to manufacture. In particular, since the flexible PCB is used as a membrane, there is no need for a mechanical cover and the overall number of components can be reduced.

FIG. 2 shows an example of a flexible PCB 20 that can be used in the system of FIG. 1 in a view from above. The depicted side of the flexible PCB 20 is the second surface 22, which is configured to be arranged away from the environment. In the depicted example, the flexible PCB 20 comprises a first portion 23, a second portion 24 and a third portion 25. The first portion 23 has a circular shape and extends into the second portion 24, which is elongate. The second portion 24 connects the first portion 23 to the third portion 25. A width of the third portion 25 is greater than a width of the second portion 24 so as to be able to accommodate a further electronic component, such as a rigid PCB 50 (shown in dotted lines). The first portion 23 of the flexible PCB 20 is configured to act as a membrane of a microphone, i.e. to vibrate as a reaction to acoustic waves when the flexible PCB 20 is arranged in the microphone system 100.

The flexible PCB 20 comprises a plurality of traces 26 that are printed on the flexible PCB 20 and that are configured to connect various components arranged on the flexible PCB 20 to each other. A sensor 30 (shown in dotted lines) may be arranged on the first portion 23 of the flexible PCB 20. It may be connected to the traces 26 and configured to transmit the output signal to another electronic component via the traces 26. The sensor 30 may be soldered on the flexible PCB 20.

In one example, the sensor 30 is arranged at a center 31 of the first portion 23, which is the most stressed region of the first portion 23. With this, the vibrations of the flexible PCB 20 can be sensed with a high precision and sensitivity. However, the sensor 30 can be arranged at a different position on the flexible PCB 20. In an example, the sensor 30 is arranged at an edge of the first portion 23 of the flexible PCB 20 or on the elongate second portion 24. In a further example, the sensor 30 comprises a plurality of sensors, wherein the plurality of sensors are arranged at different positions on the flexible PCB 20.

The third portion 25 of the flexible PCB 20 is configured to be connected to a further electronic component. In one example, the flexible PCB 20 is connected to an amplifier circuit configured to receive the electrical signal from the sensor 30, amplify the electric signal and send the amplified electric signal to a control board of a vehicle. The further electronic component may also be configured to drive the sensor 30.

Other configurations of the flexible PCB 20 are possible depending on the desired application and overall design of the microphone. In one example, the flexible PCB 20 merely comprises the first portion 23. In one example, the first portion 23 has a circular shape and a diameter of the first portion 23 of the flexible PCB 20 is 30 mm. With this, a very compact arrangement can be obtained. In one example, the first portion 23 has a polygonal or an oval shape.

In the depicted example, a thickness of the flexible PCB 20 is 0.11 mm and the flexible PCB 20 comprises the following stack-up: a first polyimide layer having a thickness of 25 μm, a layer of adhesive having a thickness of 25 μm, a copper layer having a thickness of 35 μm, and a second polyimide layer having a thickness of 25 μm. With this arrangement, the flexible PCB can detect even weak acoustic waves.

In one example, a stiffener ring is arranged around the flexible PCB 20. This makes the flexible PCB 20 more resistant against impacts.

The sensor, stack-up and exact shape of the flexible PCB 20 may vary. However, it is important that at least a part of the flexible PCB can be used as a membrane, either alone or together with another material configured to increase the strength of the flexible PCB.

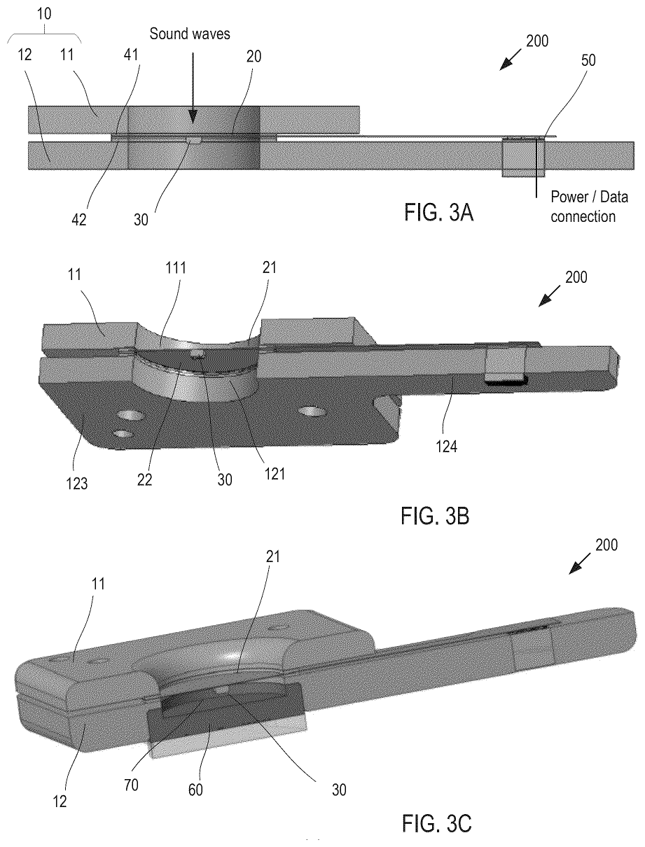

FIGS. 3A and 3B show cross-sectional areas of a microphone system 200 in a side view and in a perspective view from below, respectively. The system 200 of FIGS. 3A, 3B and 3C is based on the system of FIG. 1, wherein the flexible PCB 20 is identical with the flexible PCB of FIG. 2. In the depicted example, the housing 10 comprises a first housing part 11 and a second housing part 12 that are arranged on top of each other and are separated by a small gap. The flexible PCB 20 is arranged between the first housing part 11 and the second housing part 12 such that it is clamped between the two housing parts 11 and 12. The first housing part 11 comprises a first opening 111 and the second housing part 12 comprises a second opening 121. The first opening 111 and the second opening 121 are aligned with each other in a vertical direction and form together an opening 110 through the housing 10. In one example, the first opening 111 and the second opening 121 both have a cylindrical shape. The first opening 111 and the second opening 121 may have an identical shape.

In one example, the first housing part 11 and the second housing part 12 are manufactured by 3D printing. In another example, the first housing part 11 is manufactured by 3D printing and the second housing part 12 is a polymer material that is manufactured by laser cutting. The second housing part 12 may be made of an acrylic material. In a further example, the first housing part 11 and the second housing part 12 are made of plastic material by injection molding. Alternatively, the first housing part 11 and the second housing part 12 are made of metal.

In the depicted example, the flexible PCB 20 covers a first end of the first opening 111 and a first end of the second opening 121. Specifically, the first portion 23 of the flexible PCB 20 extends between the first housing part 11 and the second housing part 12. The sensor 30 is arranged on the second side 22 of the first portion 23 of the flexible PCB 20, away from the outer environment. In the depicted example, the sensor 30 is arranged in the middle of the first portion 23.

The flexible PCB 20 is attached to the housing parts 11 and 12 via a mounting element 40. The mounting element 40 comprises a pair of supporting elements 41 and 42 that are connected to the housing 10. The supporting elements 41 and 42 are arranged on the first surface 21 and on the second surface 22 of the flexible PCB 20, respectively. The first supporting element 41 is thus arranged between a bottom surface of the first housing part 11 and the first surface 21 of the flexible PCB 20, while the second supporting element 42 is arranged between a top surface of the second housing part 12 and the second surface 22 of the flexible PCB 20. In one example, the flexible PCB 20 is clamped between the pair of supporting elements 41 and 42. In another example, the edge of the first portion 23 of the flexible PCB 20 comprises a plurality of through-holes. The supporting elements 41 and 42 are melt by ultrasonic welding such that the material of the supporting elements 41 and 42 flows into the through-holes around the edge of the first portion 23 of the flexible PCB 20, thereby securing the first portion 23 of the flexible PCB 20. With this, a very secure mounting can be obtained. In one example, the supporting elements 41 and 42 are arranged such that a pressure on the supporting elements 41 and 42 is even. In one example, the supporting elements 41 and 42 are configured as rings and are arranged on edges of the first portion 23 of the flexible PCB 20. A diameter of the circular first portion 23 of the flexible PCB 20 may be larger than a diameter of the openings 111 and 121. The pair of supporting elements 41 and 42 may be made of a sealing material. In one example, the supporting elements 41 and 42 are made of rubber. In one example, the supporting elements 41 and 42 are made of a foam material. In one example, the supporting elements 41 and 42 are O-rings made of a material having a hardness of at least Shore 60A. With this, the electronic components of the microphone, in particular the sensor 30, can be sealed away from the environment and efficiently protected from dirt and from the environmental conditions. The supporting elements 41 and 42 can also help dampen external vibrations picked up by the housing 10. With this, the microphone system is less prone to the vibrations transmitted to the housing 10 by the environment, such as the vibrations of a car, which can improve the performance of the microphone system.

In the depicted example, the second housing part 12 comprises a first portion 123, which comprises the second opening 121, and a second portion 124 that is elongate. The second, elongate portion 24 and the third portion 25 of the flexible PCB 20 are mounted to the second portion 124 of the second housing part 12. With this, the second and the third portions 24 and 25 of the flexible PCB 20 can be supported by the second portion 124 of the second housing part 12, thereby keeping the flexible PCB 20 taut and improving the overall strength of the system 100.

The system 200 further comprises a second PCB 50 that is attached to the housing 10 and to the flexible PCB 20. The second PCB 50 is connected to the sensor 30 via the traces 26 of the flexible PCB 20 and is configured to receive and process the electrical signal from the sensor 30. In one example, the second PCB 50 is soldered to the third portion 25 of the flexible PCB 20. In one example, the second PCB 50 is mounted to the second portion of the second housing part 12 and is arranged between the third portion 25 of the flexible PCB 20 and the second, elongate portion of the second housing part 12. With this, the flexible PCB 20 can be easily connected to the second PCB 50. The first portion 23 of the flexible PCB 20 and the second PCB 50 are arranged in a same plane. In one example, the second PCB 50 comprises an analog amplifier circuit that is configured to amplify the sensor signal. In one example, the second PCB 50 is connected to an electronic system of a vehicle. The second PCB 50 is configured to output a signal indicative of the acoustic wave received by the flexible PCB 20 to the electronic system. The electronic system may be configured to supply the second PCB 50 with energy. The electronic system may also be configured to control the second PCB 50 and/or the sensor 30. The electronic system of the vehicle may then trigger an action based on the signal from the second PCB 50. In one example, the second PCB 50 is connected to the electronic system via wires. In another example, the second PCB 50 is connected to the electronic system via press-fit pins. With the use of press-fit pins, there is no need to use any wires inside the microphone, which simplifies the assembly of the microphone system.

In one example, the second PCB 50 is a rigid PCB. With this, the microphone system can be more robust and more reliable. In particular, the second PCB 50 can be used to support the end of the flexible PCB 20 and to mount it to the housing 10 in a stable manner. In another example, the flexible PCB 20 and the second PCB 50 are combined and designed as a single piece by using a rigid-flex design or by mounting all components on a single flexible PCB. Using a rigid-flex PCB design makes it easier to assemble the final product because the microphone membrane and the second PCB are already connected to each other. This is also a cost-efficient solution. Alternatively, a single flexible PCB 20 can be used, wherein the amplifying circuitry is arranged at the third portion 25 of the flexible PCB 20.

In the example of FIGS. 3A and 3B a second end of the second opening 121 of the second housing part 12 that is opposite the first end of the second opening 121 is left open. In order to fully protect the sensor 30 from the environment, the second end of the second opening 121 may be closed. For this purpose, the system 200 may further comprise closing element that covers the second end of the second opening 121. In the example depicted in FIG. 3C, the closing element is a removable plug element 60. In one example, the removable plug element 60 is inserted into the second through-hole 121 of the second housing part 12. The plug element 60 has a shape that is complementary to the second opening 121. In one example, the plug element 60 has a disk shape. The second surface 22 of the first portion 23 of the flexible PCB 20, the second housing part 12 and the plug element 60 form a cavity 70. This cavity is sealed by the second supporting element 42 and the plug element 60. The plug element 60 may be made of a sealing material. In one example, the plug element is made of a plastic material. Alternatively, the closing element is a bottom wall of the second housing part 12. Measurements have shown that the acoustic performance of the microphone system 200, in particular the frequency response of the microphone, are greatly improved when the second opening 121 is closed off. Further, resonances in the frequency response can be reduced by closing off the second opening 121.

The frequency response of microphone strongly depends on the geometry of the membrane, in particular its shape and size, and the housing 10. The frequency response can thus be tuned by tuning the dimensions of the membrane (i.e., PCB 20) and the housing 10. The frequency response of microphone also strongly depends on the volume of the air enclosed in the cavity 70. In one example, the volume of the cavity 70 may be varied by using different kinds of plug elements 60. The plug elements 60 can be replaced easily. This makes it possible to tune the frequency response of the microphone in a very simple and quick manner. The plug elements 60 may be manufactured by 3D printing. With this, they are cost-efficient and easy to manufacture. In one example, a distance between the second surface 22 of the flexible PCB 20 and the plug element 60 is 1 mm or less. In another example, a distance between the second surface 22 of the flexible PCB 20 and the plug element 60 is at least 3 mm. Measurements have shown that a larger space behind the membrane improves the frequency response of the device. Microphones having the design of FIG. 3C exhibit good acoustic properties. In particular, a sensitivity of −11 dBV at 1 kHz could be achieved. The test signal was a 1 kHz sine wave at 94 dBSPL. dBSPL describes the sound pressure level of the test signal coming from the speaker relative to 20 μPa, which corresponds to 0 dBSPL. 94 dBSPL corresponds to 1 Pa. dBV describes the electric signal coming from the microphone relative to 1 V, wherein a value of −11 dbV approximately corresponds to 0.28 V. Further, a self-noise of −72 dBV between 50 Hz and 20 kHz could be achieved. The self-noise is an A-weighted value that accounts for the relative loudness perceived by the human ear at different frequencies.

The fully sealed construction of the system 200 of FIG. 3C makes it possible to efficiently protect the electronic components of the microphone against the environment, in particular against water, dust and other impurities, as well as against temperature variations. Further, since the system 200 does not comprise any port hole for air entry, there is no danger of clogging.

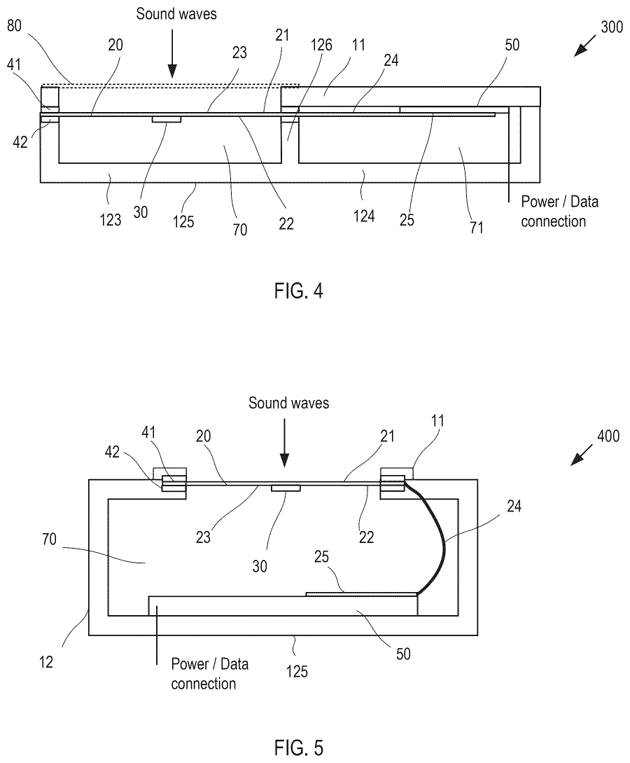

FIG. 4 shows another example of a microphone system 300 presented in a side view. Compared with the example of FIGS. 3A, 3B and 3C, the second housing part 12 of the housing 10 comprises a bottom wall 125 that closes off the second end of the second opening 121. The flexible PCB 20 and the first portion 123 of the second housing part 12, which comprises the second opening 121, thus form a closed cavity 70 which encompasses the sensor 30 and protects it form the environment. The cavity 70 is sealed by the second supporting element 42 arranged between the second surface 22 of the first portion 23 of the flexible PCB 20 and the second housing part 12. There is no need for an additional plug element. The system 300 is thus easy to assemble as it requires a reduced number of components.

Further, the housing 10 comprises a second cavity 71 that is separated from the first cavity 70 by a side wall 126 of the second housing part 12. The second cavity 71 is formed by the first housing part 11 and the second portion 124 of the second housing part 12. More specifically, the second portion 124 of the second housing part 12 comprises a third opening that is closed on one end by the bottom wall 125 and on the other end by a wall of the first housing part 11. The flexible PCB 20 extends through the second cavity 71 and is connected to the second PCB 50. In the depicted example, the second PCB 50 is attached to the wall of the first housing part 11. With this, the second PCB 50, and thus the flexible PCB 20, can be robustly supported by the housing 10. In one example, the flexible PCB 20 is flat and the third portion 25 of the flexible PCB 20 is connected to the second PCB 50. The flexible PCB 20 and the second PCB 50 are arranged in the same plane. The second cavity 71 makes it possible to also protect the electronic components of the second PCB 50 from the environment. The second PCB 50 may be connected to a control board device of an automobile. The second PCB 50 may be configured to exchange data with the control board device and may be powered by the control board device. In the depicted example, the second cavity 71 is sealed by the first and second supporting elements 41 and 42.

Impurities from the environment may accumulate on the flexible PCB 20 and negatively impact the performance of the flexible PCB 20 as a membrane, in particular dampen the vibrations of the flexible PCB 20, thereby reducing a sensitivity of the microphone system. In particular, they may affect the vibration behavior of the flexible PCB 20. In order to prevent this problem, a protection device 80 (shown in dotted lines) may be arranged on a second end of the first opening 111 of the first housing part 11. In one example, the protection device 80 comprises a plurality of though-holes. The through-holes have a diameter that is sufficiently large so that the protection device 80 is not clogged by small particles. With this, the protection device 80 is particularly easy to clean. In one example, the protection device 80 is a grid or a mesh. The protection device 80 may be made of plastic. The protection device 80 is configured to protect the flexible PCB 20 from external influences and can prevent debris and dust from accumulating on the first surface 11 of the flexible PCB 20. In particular, the protection device 80 can protect the membrane from impacts, such as stone impacts from the wheels of other cars when the microphone system is arranged on the outer side of a car.

FIG. 5 shows a further example of a microphone system 400 presented in a side view. Compared to the system of FIG. 4, the second portion 24 of the flexible PCB 20 is bent. In the depicted example, the flexible PCB 20 is bent by 180 degrees. This makes it possible to arrange the second PCB 50, which is connected to the flexible PCB 20, below the first portion 23 of the flexible PCB 20. The first portion 23 of the flexible PCB 20 and the second PCB 50 are arranged parallel to each other in two different planes and overlap. With this, a very compact arrangement can be achieved. However, other arrangements in which the flexible PCB 20 is bent are possible. In one example, the flexible PCB 20 is bent by 90 degrees and the second PCB is arranged orthogonal to the flexible PCB 20. Although it is possible to bend the flexible PCB 20 at will, it is preferable that a bending radius of the flexible PCB 20 is not too small in order to prevent damages to the electronic components arranged on the flexible PCB 20. In one example, the bending radius of the flexible PCB is at least ten times larger than a thickness of the flexible PCB 20. In one example, the bending radius of the flexible PCB 20 is at least 1 mm, preferably at least 1.5 mm.

With the system of FIG. 5, the second portion 124 of the second housing part 12 can be omitted. The obtained system is thus not only more compact, it is also easier to manufacture. In the depicted example, the second housing part 12 comprises a bottom wall 125 that is configured to close the second opening of the second housing part 12. The second surface 22 of the first portion 23 of the flexible PCB 20 and the second housing part 12 thus form a cavity 70. The cavity 70 encloses both the sensor 30, which is arranged on the second surface 22 of the first portion 23 of the flexible PCB 20, and the second PCB 50. A first surface of the second PCB 50 is arranged on the bottom wall 125 of the second housing part 12 and the third portion 25 of the flexible PCB 20 is arranged on a second surface of the second PCB 50 that is opposite the first surface of the second PCB 50. With this, the system is particularly robust. The cavity 70 is sealed by the second supporting element 42 arranged between the second surface 22 of the first portion 23 of the flexible PCB 20 and the second housing part 12. This makes it possible to protect the sensor 30 and the second PCB 50 from the environment, in particular from moisture and dust, by using a single cavity. Since the cavity is closed by the bottom wall 125 of the second housing part 12, there is also no need for an additional plug element.

In the depicted example, the first housing part 11 is designed as a clamping element that covers the first supporting element 41. The first portion 23 of the flexible PCB 20 is thus clamped between the first housing part 11 and the second housing part 12. In one example, the second portion 24 of the flexible PCB 20, which is bent, is led through an opening in the housing 10. In one example, the opening is arranged in the second housing part 12. The opening may be arranged at edges of the supporting elements 41 and 42. In one example, the first and the second housing part are designed as a single piece. This can be helpful for simplifying the assembly.

The present application describes a system that is configured to be used as microphone in a vehicle. A flexible PCB is used as a microphone membrane and a MEMS sensor is mounted to the flexible PCB. When an acoustic wave reaches the flexible PCB, the flexible PCB vibrates. The vibrations are measured by the sensor and transmitted to an amplifier circuit, which can be connected to an automobile electronics. The empty side of the flexible PCB faces the environment, while the side with the MEMS sensor may be enclosed in a sealed cavity. This setup eliminates the need for a port hole, which is usually necessary for the sound to enter the housing and reach the diaphragm of the microphone, and protects the electronics from the environment, in particular from water and dust, thereby improving the performance and the sensitivity of the microphone. Since the microphone components are sealed from the environment, it is possible to prevent the clogging of impurities inside the microphone. The proposed system is easy to manufacture because all the necessary components can be placed on a single flexible or rigid-flex PCB. Further, if press-fit pins are used for connecting the PCB to the external electronic system, no wires are needed in the microphone itself, which further simplifies the assembly. The assembly can be rendered even easier when a single rigid-flex PCB is used is the system, because there is no longer a need to connect the membrane with the PCB that comprises the amplifier circuit. In addition, a very compact assembly can be obtained when the flexible PCB used as a membrane is bent. The described system can be implemented in vehicles, in particular as a compact microphone on the inner or outside surface of a vehicle. The system can be used for emergency vehicle detection or for listening to voice commands from a user, even when the user is outside the vehicle.

Although various embodiments have been illustrated and described with respect to one or more specific implementations, alterations and/or modifications may be made to the illustrated examples without departing from the spirit and scope of the features and structures recited herein. With particular regard to the various functions performed by the above described components or structures (units, assemblies, devices, circuits, systems, etc.), the terms (including a reference to a “means”) used to describe such components are intended to correspond—unless otherwise indicated—to any component or structure that performs the specified function of the described component (e.g., that is functionally equivalent), even if it is not structurally equivalent to the disclosed structure that performs the function in the herein illustrated exemplary implementations of the present disclosure.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

What is claimed is:

1. A system comprising:
a housing;
a flexible printed board circuit, PCB, having a first surface that is exposed to an environment and a second surface that is opposite the first surface, wherein the flexible PCB is mounted to the housing by a mounting element and at least a first portion of the flexible PCB is configured to vibrate when an acoustic wave reaches the first surface; and
a sensor that is arranged on the second surface of the flexible PCB and that is configured to measure vibrations of the flexible PCB and to output a corresponding electrical signal.

2. The system according to claim 1, wherein the mounting element comprises a pair of supporting elements that are connected to the housing and arranged on the first surface and on the second surface of the flexible PCB, respectively, wherein the flexible PCB is clamped between the pair of supporting elements.

3. The system according to claim 1, wherein the housing comprises a first housing part and a second housing part, wherein the flexible PCB is arranged between the first and the second housing part.

4. The system according to claim 3, wherein the first housing part comprises a first opening and the flexible PCB covers a first end of the first opening.

5. The system according to claim 4, wherein the second housing part comprises a second opening, wherein the second opening is aligned with the first opening, and
the system further comprises a closing element that covers a first end of the second opening.

6. The system according to claim 1, wherein the sensor is an acceleration sensor.

7. The system according to claim 1, wherein the sensor is soldered on the second surface of the flexible PCB.

8. The system according to claim 1, further comprising:
a second PCB attached to the housing, wherein the second PCB is connected to the sensor and is configured to receive and process the electrical signal from the sensor.

9. The system according to claim 8, wherein the second PCB is connected to an electronic system of a vehicle.

10. The system according to claim 8, wherein the second PCB is a rigid PCB.

11. The system according to claim 8, wherein the flexible PCB and the second PCB are designed as a single piece.

12. The system according to claim 8, wherein the sensor is arranged on the first portion of the flexible PCB and the flexible PCB comprises a second portion that is connected to the second PCB.

13. The system according to claim 12, wherein the second portion of the flexible PCB is bent.

14. The system according to claim 8, wherein the first portion of the flexible PCB and the second PCB are arranged in a same plane.

15. The system according to claim 8, wherein the first portion of the flexible PCB and the second PCB are arranged parallel to each other in two different planes and overlap.
